(19) United States
(12) Patent Application Publication
(10) Pub. No.: US 2026/0057484 A1
(43) Pub. Date: Feb. 26, 2026

(54) METHOD AND SYSTEM FOR RECONSTRUCTING MISSING INFORMATION IN DAMAGED TURBULENT FLOW FIELD

(71) Applicants: Hangzhou International Innovation Institute of Beihang University, Hangzhou (CN); The Hong Kong University of Science and Technology, Hong Kong (CN)

(72) Inventors: Qinmin Zheng, Hangzhou (CN); Lin Fu, Hong Kong (CN); Dewei Fan, Hangzhou (CN); Xi He, Hangzhou (CN); Shuai Qiao, Hangzhou (CN); Yunbing Hu, Hangzhou (CN); Chong Pan, Hangzhou (CN)

(21) Appl. No.: 19/201,946

(22) Filed: May 8, 2025

(30) Foreign Application Priority Data
Aug. 21, 2024 (CN) 202411148653.4

(51) Int. Cl. G06T 5/50; G06V 10/44

(52) U.S. Cl. CPC G06T 5/50; G06V 10/44; G06T 2207/20221

(57) ABSTRACT

The present disclosure discloses a method and system for reconstructing missing information in a damaged turbulent flow field. A second mask is randomly generated based on a first mask and is utilized in the network training, which significantly enhances the generator network's ability to recognize multiple damaged regions and generalize different damage forms. A combined loss function is introduced, which not only evaluates the overall difference between a reconstructed turbulent flow field and an original turbulent flow field, but also evaluates the difference in feature mapping at different levels of a pretrained network. This dual evaluation ensures accurate reconstruction of flow field information from macro to micro scales. Such a semi-supervised learning strategy permits network training without complete turbulent flow field data.

### CROSS-REFERENCE TO RELATED APPLICATIONS

The present disclosure claims priority to Chinese Patent Application No. CN202411148653.4, entitled “METHOD AND SYSTEM FOR RECONSTRUCTING MISSING INFORMATION IN DAMAGED TURBULENT FLOW FIELD,” filed on Aug. 21, 2024, which is incorporated by reference herein in its entirety.

### TECHNICAL FIELD

The present disclosure relates to image processing technology, and more particularly, to a method and system for reconstructing missing information in a damaged turbulent flow field.

### BACKGROUND

An accurate measurement of turbulent flow field information is crucial for understanding complex flow phenomena in fluid dynamics research and engineering applications. However, due to experimental measurement limitations, reconstructing incomplete or missing flow field information is a common challenge in important applications related to turbulent flows. Particle image velocimetry (PIV) experiments are typical examples, where various factors during the measurement, such as loss of planar particles, shadow effects, or light reflection from walls, may lead to missing flow field information. In addition, similar problems also exist in oceanographic and meteorological observations, where distorted pixels and cloud cover may lead to missing information. According to the degree of missing flow field information and the number of available samples, different methods can be employed to reconstruct a complete field description from a flow field measurement with missing information. If there are enough samples and the degree of missing flow field information is limited, reconstruction technologies relying on extracting flow features can be utilized, such as Proper Orthogonal Decomposition (POD) technology, Dynamic Mode Decomposition (DMD) technology, or their variants. However, most mode reduction methods rely on linear interpolation, which results in lower accuracy in reconstructing missing information in the turbulent flow field when dealing with complex multi-scale flows (such as a full-developed turbulent flow) and large damaged regions.

In recent years, due to the powerful ability of deep neural networks to handle nonlinear problems, deep learning technologies, especially convolutional neural networks, have achieved great success in the field of computer vision and have gradually been applied to fields such as fluid dynamics. A typical example is the successful application of a super-resolution framework based on Generative Adversarial Network (GAN) to the turbulent flow and climate data, which improves spatial resolution or fill missing information in experimental measurements. The GAN generates high-resolution and realistic flow field data through an adversarial process of a generator and a discriminator. Substantial evidence indicates that the introduction of the discriminator network significantly improves the accuracy of reconstructing the flow field. However, although the convolutional neural networks can achieve good results in the flow field reconstruction, the vast majority of existing applications require complete flow field datasets for training the flow field reconstruction framework, i.e., a fully-supervised learning mode. Due to the difficulty in obtaining a large amount of complete flow field data during the actual measurement process, reconstructing damaged turbulent flow fields by using a fully supervised learning mode has significant limitations in engineering practice.

### SUMMARY

In view of the limitations described above, the present disclosure aims to provide a method and system for reconstructing missing information in a damaged turbulent flow field. Using an innovative data preprocessing method, an advanced neural network architecture, and a customized loss function, the network can be trained to reconstruct the turbulent flow field with high fidelity using only local information of the turbulent flow field, without requiring a complete turbulent flow field dataset. To achieve the above objectives, the embodiments of the present disclosure provide the following technical solutions.

The present disclosure provides a method for reconstructing missing information in a damaged turbulent flow field, in which the damaged turbulent flow field includes multiple damaged regions and multiple intact regions, comprising the following steps:
generating a first mask based on the shape and distribution of the damaged regions, wherein the first mask includes multiple 0-value regions each having a pixel value of 0 and multiple non-zero regions each having a pixel value of 1, and the 0-value regions of the first mask cover all the damaged regions;
randomly generating a second mask based on the first mask, in which the second mask includes multiple 0-value regions each having a pixel value of 0 and multiple non-zero regions each having a pixel value of 1, and the 0-value regions of the second mask cover a portion of the intact regions, and the 0-value regions of the first mask and the 0-value regions of the second mask do not overlap with each other;
overlaying the first mask with the damaged turbulent flow field to obtain a preprocessed first damaged turbulent flow field;

inputting the first damaged turbulent flow field and the second mask into a generator network to output a first reconstructed turbulent flow field, and overlaying the first reconstructed turbulent flow field with the first mask to obtain a reconstructed second damaged turbulent flow field;
calculating a loss function of a network framework and adjusting network parameters based on the second and the first damaged turbulent flow fields;
repeating the operations from generating the second mask to calculating the loss function and adjusting the network parameters based on the second and the first damaged turbulent flow fields, until the network training converges; and
preprocessing the damaged turbulent flow field and inputting the preprocessed damaged turbulent flow field into the converged generator network to obtain a complete turbulent flow field.

In the embodiment, the randomly generated second mask is used for the training of the generator network, the training is repeated and thus the network parameters are continuously adjusted until the loss function converges, enhancing the ability of the generator network to recognize the damaged regions and generalize different damage forms, and significantly improving the reconstruction performance of an original damaged turbulent flow field.

In the embodiment, the first mask is uniquely determined according to the specific damaged turbulent flow field, and the second mask is randomly generated during the network training process; the reconstruction performance of the complete turbulent flow field is evaluated by comparing the damaged turbulent flow field with the complete turbulent flow field, and the proportion of the 0-value regions of the second mask is adjusted according to the reconstruction performance.

Therefore, by adaptively adjusting the proportion of the 0-value regions in the second mask, the reconstruction accuracy of the complete turbulent flow field can be significantly improved.

In the embodiment, the calculating a loss function of a network framework and adjusting network parameters based on the second and the first damaged turbulent flow fields includes:
comparing the second damaged turbulent flow field with the first damaged turbulent flow field, and calculating a conventional pixel mean square error loss function Lₚᵢₓ;
calculating an adversarial loss function L_{adv} of the network framework;
inputting the second and the first damaged turbulent flow fields into a pretrained network including a zero module, a first module, a second module, a third module, a fourth module and a fifth module in sequence; calculating feature mappings of the second and the first damaged turbulent flow fields in the first module, the second module, the third module and the fourth module; calculating mean square errors MSE₁, MSE₂, MSE₃ and MSE₄ respectively corresponding to the feature mappings, and calculating a weighted average value L_{fm}=α₁MSE₁+α₂MSE₂+α₃MSE₃+α₄MSE₄;
wherein the loss function is a combined loss function: L_{final}=αLₚᵢₓ+βL_{adv}+γL_{fm}, wherein α, β, and γ are weight coefficients.

In the embodiment, the combined loss function combines the weighted average of the conventional pixel mean square error and the mean square error of the network-level feature mapping. The network-level feature mapping mean square error is configured to evaluate a difference between the reconstructed turbulent flow field and the original turbulent flow field at different levels of feature mapping in the pretrained network, which ensures that the spatial scale information of the reconstructed turbulent flow field remains consistent with that of the original turbulent flow field, and overcomes the limitation that only the reconstruction of a large-scale turbulent structure can be ensured by using the conventional pixel mean square error loss function alone. The method provided in the embodiments not only considers the overall difference between the reconstructed turbulent flow field (the second damaged turbulent flow field) and the original turbulent flow field (the first damaged turbulent flow field), but also evaluates the difference between the reconstructed turbulent flow field and the original turbulent flow field in the feature mapping at different levels of the pretrained network, and thus ensures accurate reconstruction of flow field information from macro to micro scales.

In the embodiment, the generator network includes a downsampling module, a fast Fourier residual module, and an upsampling module; the downsampling module is configured to perform feature extraction and dimensionality reduction on the first damaged turbulent flow field inputted to the generator network, the fast Fourier residual module is configured to extract high-level features of the turbulent flow field in the wavenumber space, and the upsampling module is configured to remap the high-level features back to the spatial dimension of the original turbulent flow field and restore detailed information;
inputting the first damaged turbulent flow field and the second mask into a generator network to output a first reconstructed turbulent flow field, and overlaying the first reconstructed turbulent flow field with the first mask to obtain a reconstructed second damaged turbulent flow field includes:
processing the first damaged turbulent flow field and the second mask sequentially through the downsampling module, the fast Fourier residual module, and the upsampling module to output the first reconstructed turbulent flow field, overlaying the first reconstructed turbulent flow field with the first mask to obtain the reconstructed second damaged turbulent flow field;
comparing the second damaged turbulent flow field with the first damaged turbulent flow field, and calculating the conventional pixel mean square error loss function Lₚᵢₓ.

In the embodiment, before calculating a loss function of a network framework and adjusting network parameters based on the second and the first damaged turbulent flow fields, the method further includes:
inputting the second and the first damaged turbulent flow fields into a discriminator network;
dividing the second and the first damaged turbulent flow fields into multiple local flow field regions using the discriminator network;
performing feature extraction and representation learning on the local flow field regions using the discriminator network;
calculating a local discrimination result for each local flow field region using the discriminator network;
summarizing the local discrimination results using an aggregation method and calculating an overall discrimination result, wherein the overall discrimination result is used to determine an authenticity of the second damaged turbulent flow field and calculate the adversarial loss function L_{adv}.

The present disclosure further provides a system for reconstructing missing information in a damaged turbulent flow field, wherein the damaged turbulent flow field includes multiple damaged regions and multiple intact regions, and the system includes:
a data preprocessing module, configured to generate a first mask based on the shapes and distribution of the damaged regions and randomly generate a second mask based on the first mask; wherein the first mask includes multiple 0-value regions each having a pixel value of 0 and multiple non-zero regions each having a pixel value of 1, and the 0-value regions of the first mask cover all of the damaged regions; the second mask includes multiple 0-value regions each having a pixel value of 0 and multiple non-zero regions each having a pixel value of 1, and the 0-value regions of the second mask cover a portion of the intact regions of the damaged turbulent flow field; the 0-value regions of the first mask and the 0-value regions of the second mask do not overlap with each other; the first mask is overlaid on the damaged turbulent flow field to obtain a preprocessed first damaged turbulent flow field;
a generator network module, configured to receive the first damaged turbulent flow field and the second mask, and output a first reconstructed turbulent flow field, overlay the first reconstructed turbulent flow field with the first mask to obtain a reconstructed second damaged turbulent flow field;
a training module, configured to calculate a loss function of a network framework based on the second and the first damaged turbulent flow fields, adjust network parameters, iterates operations from generating the second mask to calculating the loss function based on the second and the first damaged turbulent flow fields, until the network training converges;
a reconstruction module, configured to, after the network training converges, preprocess the damaged turbulent flow field and input the preprocessed damaged turbulent flow field into the converged generator network module to obtain the complete turbulent flow field.

In the embodiment, the randomly generated second mask is used for the training of the generator network, the training is repeated and thus the network parameters are continuously adjusted until the loss function converges, enhancing the ability of the generator network to recognize the damaged regions and generalize different damage forms, and significantly improving the reconstruction accuracy of an original damaged turbulent flow field.

In the embodiment, when the pixel mean square error or the network-level feature mapping mean square error between the second and the first damaged turbulent flow fields is less than a threshold, the network training is deemed converged.

In the embodiment, the system further includes a discriminator module configured to calculate an adversarial loss function L_{adv} of the network framework;
the generator network module is further configured to compare the second damaged turbulent flow field with the first damaged turbulent flow field, and calculate a conventional pixel mean square error loss function Lₚᵢₓ;
a pretrained network configured by the training module includes a zero module, a first module, a second module, a third module, a fourth module and a fifth module in sequence, calculates feature mappings of the second and the first damaged turbulent flow fields in the first module, the second module, the third module and the fourth module, calculates mean square errors MSE₁, MSE₂, MSE₃ and MSE₄ respectively correspond to the feature mappings, and calculates a weighted average value: L_{fm}=α₁MSE₁+α₂MSE₂+α₃MSE₃+α₄MSE₄,
wherein the loss function is a combined loss function L_{final}=αLₚᵢₓ+βL_{adv}+γL_{fm}, wherein α, β, and γ are weight coefficients.

In the embodiment, the combined loss function combines the weighted average of the conventional pixel mean square error and the mean square error of the network-level feature mapping. The network-level feature mapping mean square error is configured to evaluate a difference between the reconstructed turbulent flow field and the original turbulent flow field at different levels of feature mapping in the pretrained network, which ensures that the different spatial scale information of the reconstructed turbulent flow field remains consistent with that of the original turbulent flow field, and overcomes the problem that only the reconstruction of a large-scale turbulent structure can be ensured by using the conventional pixel mean square error loss function alone. The system provided in the embodiments not only considers the overall difference between the reconstructed turbulent flow field (the second damaged turbulent flow field) and the original turbulent flow field (the first damaged turbulent flow field), but also evaluates the difference between the reconstructed turbulent flow field and the original turbulent flow field in the feature mapping at different levels of the pretrained network, and thus ensures accurate reconstruction of flow field information from macro to micro scales.

In the embodiment, the generator network module includes a downsampling module, a fast Fourier residual module, and an upsampling module. The downsampling module is configured to perform feature extraction and dimensionality reduction on the first damaged turbulent flow field inputted to the generator network; the fast Fourier residual module is configured to extract high-level features of the turbulent flow field in the wavenumber space, and the upsampling module is configured to remap the high-level features back to the spatial dimension of an original turbulent flow field and restore detailed information;
the first damaged turbulent flow field and the second mask are sequentially processed through the downsampling module, the fast Fourier residual module, and the upsampling module to output the first reconstructed turbulent flow field.

In the embodiment, the downsampling module reduces the spatial resolution of the input turbulent flow field data and extracts high-level flow field features. The fast Fourier residual module improves the reconstruction accuracy of high wavenumber information in the turbulent flow field. By performing a deconvolution operation, the upsampling module can gradually increase the size of the turbulent flow field data and reduce the number of channels, thereby gradually restoring the details and structure of the turbulent flow field, and thus more accurately restoring the structure of the damaged turbulent flow field.

In the embodiment, the discriminator module is configured to receive the second and the first damaged turbulent flow fields, divide the second and the first damaged turbulent flow fields into multiple local flow field regions, perform feature extraction and representation learning on the local flow field regions using the discriminator module, calculate a local discrimination result for each local flow field region, and aggregate the local discrimination results using an aggregation method to calculate an overall discrimination result, wherein the overall discrimination result is used to judge authenticity of the second damaged turbulent flow field and calculate the adversarial loss function L_{adv}.

In the embodiment, the discriminator network is configured to evaluate and improve the local details of the reconstructed turbulent flow field (the second damaged turbulent flow field), and is applied to each iteration process to promote the generator network to generate more realistic flow field data.

According to the method and system for reconstructing missing information in a damaged turbulent flow field provided by the present disclosure, the second mask which is randomly generated based on the first mask is used in the network training process, which significantly enhances the ability of the generator network to recognize the damaged regions and generalize different damage forms. The Generative Adversarial Network architecture provided by the present disclosure combines the generator network and the discriminator network. The generator network can extract high wavenumber features of the turbulent flow field data, while the discriminator network focuses on evaluating and improving local details of the reconstructed turbulent flow field. When calculating the loss function, a novel network-level error loss function is introduced, which uses a combined loss function. This not only considers the overall difference between the reconstructed turbulent flow field and the original turbulent flow field, but also evaluates the difference in feature mapping between the two at different levels of the pretrained network, ensuring accurate reconstruction of flow field information from macro to micro scales. This semi-supervised learning strategy enables network training without relying on complete turbulent flow field data. By utilizing local information of the turbulent flow field and masks generated by data preprocessing modules, the present disclosure can achieve efficient network training and parameter optimization using only damaged turbulent flow field data.

### BRIEF DESCRIPTION OF DRAWINGS

FIG. 1 is a flow diagram of a method for reconstructing missing information in a damaged turbulent flow field according to the embodiment of the present disclosure;

FIG. 2 is a schematic of a first mask and two types of second masks (with different proportions of 0-value regions corresponding to the first mask) for reconstructing missing information in a damaged turbulent flow field according to the embodiment of the present disclosure;

FIG. 3 is a schematic of a pretrained network for reconstructing missing information in a damaged turbulent flow field according to the embodiment of the present disclosure;

FIG. 4 is a schematic of a generator network for reconstructing missing information in the damaged turbulent flow field according to the embodiment of the present disclosure;

FIG. 5 is a schematic showing a division of local flow field regions of the method for reconstructing missing information in a damaged turbulent flow field according to the embodiment of the present disclosure;

FIG. 6 is a schematic of a discriminator network for reconstructing missing information in a damaged turbulent flow field according to the embodiment of the present disclosure; and

FIG. 7 is a schematic of a system for reconstructing missing information in a damaged turbulent flow field according to the embodiment of the present disclosure.

### DESCRIPTION OF EMBODIMENTS

Hereinafter, with reference to the accompanying drawings, the preferred embodiments of the present disclosure will be described in detail. In the following explanation, the same symbols are assigned to the same components, and repeated explanations are omitted. In addition, the accompanying drawings is only a schematic, and the dimensional proportions between components or the shape of components may differ from the actual situation.

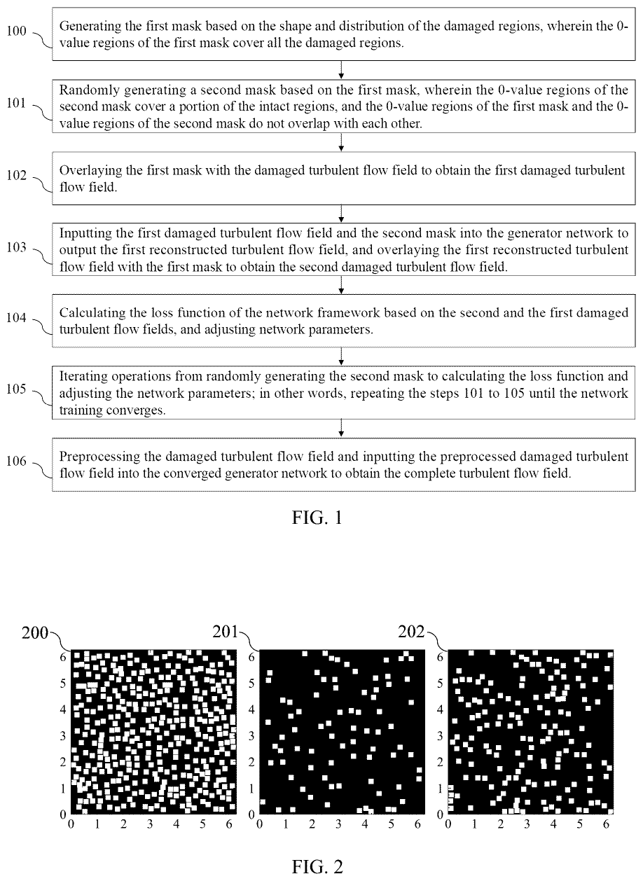

As shown in FIG. 1, the present disclosure provides a method for reconstructing missing information in a damaged turbulent flow field, which includes multiple damaged regions and multiple intact regions. The method includes the following steps.

Step 100: generating the first mask based on the shape and distribution of the damaged regions, wherein the first mask includes multiple 0-value regions each having a pixel value of 0 and multiple non-zero regions each having a pixel value of 1, and the 0-value regions of the first mask cover all the damaged regions.

Step 101: randomly generating a second mask based on the first mask, wherein the second mask includes multiple 0-value regions each having a pixel value of 0 and multiple non-zero regions each having a pixel value of 1, the 0-value regions of the second mask cover a portion of the intact regions, and the 0-value regions of the first mask and the 0-value regions of the second mask do not overlap with each other.

Step 102: overlaying the first mask with the damaged turbulent flow field to obtain the first damaged turbulent flow field.

Step 103: inputting the first damaged turbulent flow field and the second mask into the generator network to output the first reconstructed turbulent flow field, and overlaying the first reconstructed turbulent flow field with the first mask to obtain the second damaged turbulent flow field.

Step 104: calculating the loss function of the network framework based on the second and the first damaged turbulent flow fields, and adjusting network parameters.

Step 105: iterating operations from randomly generating the second mask to calculating the loss function and adjusting the network parameters; in other words, repeating steps 101 to 105 until the network training converges.

Step 106: preprocessing the damaged turbulent flow field and inputting the preprocessed damaged turbulent flow field into the converged generator network to obtain the complete turbulent flow field.

In this embodiment, the randomly-generated second mask is used for the training of the generator network, and the training is repeated. The network parameters are continuously adjusted until the loss function converges, enhancing the ability of the generator network to recognize the damaged regions and generalize different damage forms, and significantly improving the reconstruction accuracy of the original damaged turbulent flow field.

In this embodiment, when the pixel mean square error or the network-level feature mapping mean square error between the second and the first damaged turbulent flow fields is less than a threshold, the network training is deemed converged.

In this embodiment, the first mask is uniquely determined based on the specific damaged turbulent flow field, and the second mask is randomly generated during the network training. The reconstruction accuracy of the complete turbulent flow field is evaluated by comparing the damaged turbulent flow field with the complete turbulent flow field, and the proportion of the 0-value regions of the second mask is adjusted according to the reconstruction accuracy. Therefore, by adaptively adjusting the proportion of the 0-value regions in the second mask, the reconstruction accuracy can be significantly improved.

In some embodiments, as shown in FIG. 2, the first mask 200 is generated based on the damaged regions of the original turbulent flow field. The first mask is uniquely determined according to the specific damaged turbulent flow field, and the 0-value regions of the first mask precisely cover all the damaged regions in the flow field, which thus provides an accurate regional indication for a subsequent flow field reconstruction. For ease of understanding, the 0-value regions of the first mask 200 are illustrated as uniformly sized squares. In some embodiments, the number, locations, and shapes of the 0-value regions in the first mask can be determined based on the damaged regions of the original turbulent flow field which may have different shapes.

As shown in FIG. 2, the second masks 201 and 202 correspond to the first mask 200 with different proportions of the 0-value regions. The second masks (201 and 202) are randomly generated based on the first mask 200, and the proportion of the 0-value regions may be adjusted appropriately according to the reconstruction performance. The 0-value regions of the first mask 200 do not overlap with those of the second masks (201 and 202).

In this embodiment, the intact regions refers to regions where the turbulent flow field remained undamaged. The 0-value regions of the second mask (201 and 202) are randomly distributed within the intact regions of the turbulent flow field.

In some embodiments, the network parameters may include filter dimensions, weights and biases of neurons.

In this embodiment, when the pixel mean square error or the network-level feature mapping mean square error between the second and the first damaged turbulent flow fields is less than a threshold, the network training is deemed converged. In other words, during the network training, an appropriate threshold can be set for a concerned physical quantity, such as the mean square error of the reconstructed turbulent flow field (the second damaged flow field) and the original turbulent flow field (the first damaged flow field) in the 0-value regions of the second mask; when the physical quantity reaches the threshold, the network training is deemed converged.

In some embodiments, during the network training process, it is necessary to closely monitor the changes in the loss function and the reconstruction accuracy of the turbulent flow field, and adjust the network structure and the weight of the loss function if necessary to ensure the final reconstruction quality.

In this embodiment, step 104 includes the following steps.

Comparing the second damaged turbulent flow field with the first damaged turbulent flow field, and calculating a conventional pixel mean square error loss function Lₚᵢₓ.

Calculating an adversarial loss function L_{adv} of the network framework.

Inputting the second and the first damaged turbulent flow fields into a pretrained network which includes a zero module, a first module, a second module, a third module, a fourth module and a fifth module in sequence, calculating a feature mapping of the second and the first damaged turbulent flow fields in the first module, the second module, the third module and the fourth module respectively; mean square errors MSE₁, MSE₂, MSE₃, MSE₄ respectively corresponding to the feature mappings are calculated, and a weighted average value is given as L_{fm}=α₁MSE₁+α₂MSE₂+α₃MSE₃+α₄MSE₄, wherein α₁, α₂, α₃ and α₄ are weight coefficients.

The loss function is a combined loss function: L_{final}=αLₚᵢₓ+βL_{adv}+γL_{fm}, wherein α, β, and γ are weight coefficients.

In the embodiment, the combined loss function combines the weighted average of the conventional pixel mean square error and the mean square error of a network-level feature mapping mean square error. The network-level feature mapping mean square error is configured to evaluate the difference between the reconstructed and the original turbulent flow field at different levels of feature mapping in the pretrained network, which ensures that the different spatial scale information of the reconstructed turbulent flow field remains consistent with that of the original turbulent flow field, and overcomes the problem that only the reconstruction of a large-scale turbulent structure can be ensured by using the conventional pixel mean square error loss function alone. The method provided in the embodiments not only considers the overall difference between the reconstructed turbulent flow field (the second damaged turbulent flow field) and the original turbulent flow field (the first damaged turbulent flow field), but also evaluates the difference between the reconstructed and the original turbulent flow filed in the feature mapping at different levels of the pretrained network, and thus ensures accurate reconstruction of flow field information from macro to micro scales.

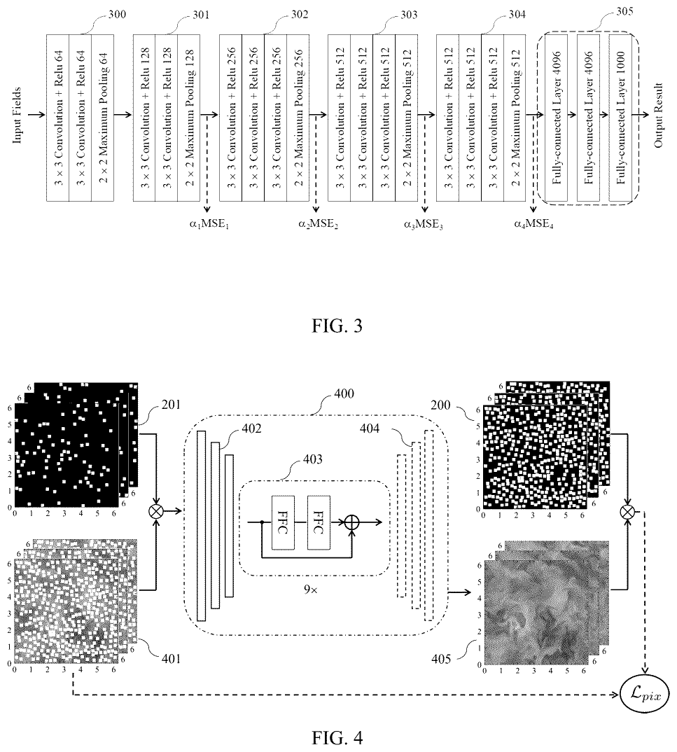

In some embodiments, as shown in FIG. 3, the pretrained network sequentially includes a zero module 300, a first module 301, a second module 302, a third module 303, a fourth module 304, and a fifth module 305. The second and the first damaged turbulent flow fields are respectively input into the pretrained network, and the feature mapping and the mean square error MSE1 of the second and the first damaged turbulent flow fields in the first module 301, the feature mapping and the mean square error MSE2 of the second and the first damaged turbulent flow fields in the second module 302, the feature mapping and the mean square error MSE3 of the second and the first damaged turbulent flow fields in the third module 303, and the feature mapping and the mean square error MSE4 of the second and the first damaged turbulent flow fields in the fourth module 304 are calculated in sequence. In this embodiment, only the feature mappings and the mean square errors of the first module 301, the second module 302, the third module 303, and the fourth module 304 are calculated, which not only reduces the calculation cost but also highlights advanced features of the turbulent flow field.

In this embodiment, the pretrained network adopts a VGG-16 network model.

In some embodiments, as shown in FIG. 4, the generator network 400 includes a downsampling module 402, a fast Fourier residual module 403, and an upsampling module 404. The downsampling module 402 is configured to perform feature extraction and dimensionality reduction on a first damaged turbulent flow field 401. The fast Fourier residual module 403 is configured to extract the advanced features of the turbulent flow field in the wavenumber space. The upsampling module 404 is configured to remap the advanced features back to the spatial dimensions of the original turbulent flow field and restore detailed information.

Step 103 includes the following steps.

Processing the first damaged turbulent flow field 401 and the second mask 201 through the downsampling module 402, the fast Fourier residual module 403, and the upsampling module 404 in sequence to output the first reconstructed turbulent flow field 405, and overlaying the first reconstructed turbulent flow field 405 with the first mask 200 to obtain the reconstructed second damaged turbulent flow field.

Comparing the second damaged turbulent flow field with the first damaged turbulent flow field 401 and calculating the conventional pixel mean square error loss function Lₚᵢₓ.

In this embodiment, the downsampling module 402 reduces the spatial resolution of the input turbulent flow field data and extracts high-level flow field features. The fast Fourier residual module 403 improves the reconstruction accuracy of high wavenumber area information in the turbulent flow field. By performing deconvolution operations, the upsampling module 404 can gradually increase the size of the turbulent flow field data and reduce the number of channels, thereby progressively restoring the details and structure of the turbulent flow field, and thus more accurately restoring the structure of the damaged turbulent flow field.

In some embodiments, the downsampling module 402 includes a series of convolutional and pooling layers which can reduce the spatial resolution of the input turbulent flow field data and extract the high-level flow field features. By performing multiple convolution and pooling operations, the downsampling module 402 can gradually reduce the size of the turbulent flow field data and increase the number of channels to obtain higher-level feature representations.

In some embodiments, the fast Fourier residual module 403 may include multiple feedforward network units similar to ResNet and two fast Fourier convolutions (FFCs). The fast Fourier residual module 403 is configured to extract the turbulent flow field information in the wavenumber space, which improves the reconstruction accuracy in high wavenumber regions of the turbulent flow fields.

In some embodiments, the upsampling module 404 includes a series of deconvolution and convolutional layers. The upsampling module 404 is configured to remap the high-level features extracted by the fast Fourier residual module 403 back to the spatial dimension of the original turbulent flow field and restore detailed information. By performing a deconvolution operation, the upsampling module 404 can gradually increase the size of the turbulent flow field data and reduce the number of channels, thereby gradually restoring the details and structure of the turbulent flow field.

In some embodiments, before step 104, the method further includes the following steps:
inputting the second and the first damaged turbulent flow fields into a discriminator network;
dividing the second and the first damaged turbulent flow fields into several local flow field regions using the discriminator network;
performing feature extraction and representation learning on the local flow field regions using the discriminator network;
calculating the local discrimination result for each local flow field region using the discriminator network; and
summarizing the local discrimination results using an aggregation method and calculating an overall discrimination result, wherein the overall discrimination result is configured to determine the authenticity of the second damaged turbulent flow field and calculate the adversarial loss function L_{adv}.

In this embodiment, the discriminator network can be configured to evaluate and improve the local details of the reconstructed turbulent flow field (the second damaged turbulent flow field), and is applied to each iteration process to promote the generator network to generate more real flow field data.

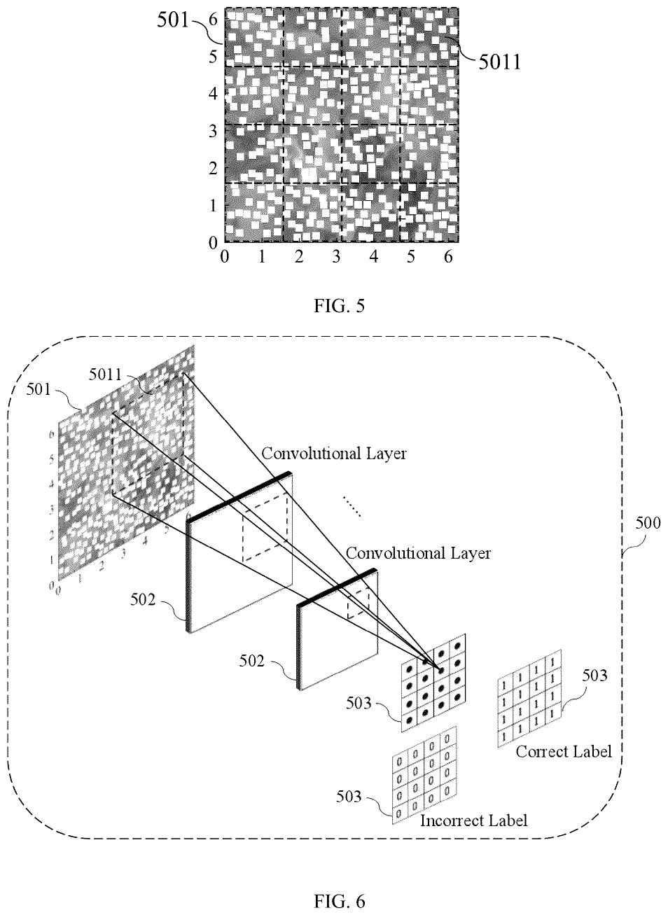

In some embodiments, as shown in FIG. 5, the turbulent flow field 501 is divided into multiple local flow field regions 5011. The turbulent flow field 501 includes the second and the first damaged turbulent flow fields. In this embodiment, the turbulent flow field 501 is divided into 16 non-overlapping local flow field regions of the same size. In other embodiments, the local flow field regions can overlap with each other, and the size of each local flow field region can be adjusted according to specific applications.

In some embodiments, as shown in FIG. 6, the feature extraction and the representation learning are performed on each local flow field region 5011 by using a discriminator network. The discriminator network 500 includes multiple convolutional layers 502 each of which uses learnable convolution kernels to extract features of the local flow field region. The discriminator network 500 can further include pooling layers, batch normalization layers, and activation functions (such as LeakyReLU) between the convolutional layers 502, which improves the representational and discriminative abilities of the discriminator network 500. For each local flow field region 5011, the discriminator network 500 generates a local discrimination result. The local discrimination result can be a binary classification (true/false) or a probability value, indicating the probability that the local flow field region is a real flow field. In this embodiment, the output of the discriminator network 500 is a two-dimensional array 503 containing binary labels. When the values of all the local flow field regions 5011 in the two-dimensional array 503 are 1, it indicates that the authenticity of the reconstructed flow field is high. Conversely, when all values are 0, it indicates low authenticity of the reconstructed flow field.

In this embodiment, the discriminator network is a PatchGAN discriminator network. Thus, the discriminator network can capture local details and structural information of the turbulent flow field, enabling it to evaluate the authenticity of the reconstructed flow field in more detail. The PatchGAN discriminator network aggregates all the local discrimination results using global pooling, fully-connected layers, or other aggregation methods. The final discrimination result represents the authenticity score of the flow field.

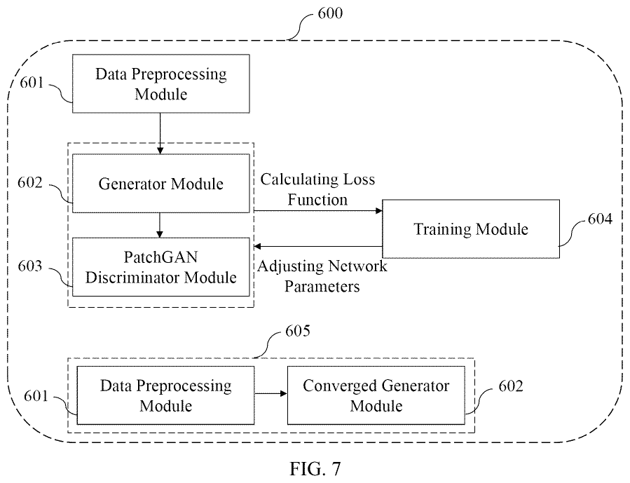

The present disclosure further provides a system 600 for reconstructing missing information in a damaged turbulent flow field, which includes multiple damaged regions and multiple intact regions. As shown in FIG. 7, the system 600 comprises a data preprocessing module 601, a generator network module 602, a training module 604, and a reconstruction module 605.

The data preprocessing module 601 is configured to generate a first mask based on the shape and distribution of the damaged regions. The first mask includes multiple 0-value regions covering all the damaged regions. A second mask is randomly generated based on the first mask, and the second mask includes multiple 0-value regions covering a portion of the intact regions. The 0-value regions of the first mask and the 0-value regions of the second mask do not overlap with each other. The first mask is overlaid on the damaged turbulent flow field to obtain a preprocessed first damaged turbulent flow field.

The generator network module 602 is configured to receive the first damaged turbulent flow field and the second mask, and output the first reconstructed turbulent flow field. The first reconstructed turbulent flow field overlays with the first mask to obtain the second damaged turbulent flow field.

The training module 604 calculates a loss function of the network framework, adjusts network parameters based on the second and first damaged turbulent flow fields, and iterates operations from generating the second mask to calculating the loss function and adjusting the network parameters based on the second and first damaged turbulent flow fields until the network training converges.

The reconstruction module 605, after the network training converges, is configured to preprocess the damaged turbulent flow field and input the preprocessed damaged turbulent flow field into the generator network module to obtain the complete turbulent flow field.

In this embodiment, the randomly-generated second mask is used for the network training. The training is repeated and the network parameters are continuously adjusted until the loss function converges, which improves the generator network's ability to recognize the damaged regions and generalize different damage forms, significantly improving the reconstruction accuracy of the original damaged turbulent flow field.

In this embodiment, when the pixel mean square error or the network-level feature mapping mean square error of the second and the first damaged turbulent flow fields is less than a threshold, the network training is deemed converged.

In this embodiment, the system 600 further includes a discriminator module 603 configured to calculate an adversarial loss function L_{adv} for the network framework.

The generator network module 602 is further configured to compare the second damaged turbulent flow field with the first damaged turbulent flow field, and calculate a conventional pixel mean square error loss function Lₚᵢₓ.

In this embodiment, as shown in FIG. 3, the training module 604 is configured with a pretrained network. The pretrained network includes a zero module 300, a first module 301, a second module 302, a third module 303, a fourth module 304 and a fifth module 305. The pretrained network calculates feature mappings of the second and the first damaged turbulent flow fields in the first module 301, the second module 302, the third module 303, and the fourth module 304. The mean square errors MSE₁, MSE₂, MSE₃, MSE₄ respectively corresponding to the feature mappings are calculated, and a weighted average value is given as L_{fm}=α₁MSE₁+α₂MSE₂+α₃MSE₃+α₄MSE₄, wherein α₁, α₂, α₃ and α₄ are weight coefficients.

The loss function is a combined loss function: L_{final}=αLₚᵢₓ+βL_{adv}+γL_{fm}, wherein α, β, and γ are weight coefficients.

In this embodiment, the loss function combines the weighted average of the conventional pixel mean square error and the network-level feature mapping mean square error. The network-level feature mapping mean square error is configured to evaluate the difference between the reconstructed and the original turbulent flow field at different levels of feature mapping in the pretrained network, which ensures that the different spatial scale information of the reconstructed turbulent flow field remains consistent with that of the original turbulent flow field, and overcomes the limitation that only the reconstruction of a large-scale turbulent structure can be ensured by using the conventional pixel mean square error loss function alone. The system of the embodiment not only considers the overall difference between the reconstructed turbulent flow field (the second damaged turbulent flow field) and the original turbulent flow field (the first damaged turbulent flow field), but also evaluates the difference between the reconstructed and the original turbulent flow filed in the feature mapping at different levels of the pretrained network, and thus ensures accurate reconstruction of flow field information from macro to micro scales.

In this embodiment, the generator network module 602 configures a generator network 400. As shown in FIG. 4, the generator network 400 includes a downsampling module 402, a fast Fourier residual module 403, and an upsampling module 404. The downsampling module 402 is used for performing feature extraction and dimensionality reduction on a first damaged turbulent flow field 401. The fast Fourier residual module 403 is configured to extract advanced features of the turbulent flow field in the wavenumber space. The upsampling module 404 is configured to remap the advanced features back to the spatial dimensions of the original flow field and restore detailed information. The first damaged turbulent flow field 401 and the second mask 201 are sequentially processed through the downsampling module 402, the fast Fourier residual module 403, and the upsampling module 404 to output a first reconstructed turbulent flow field 405. The first reconstructed turbulent flow field 405 is then overlaid with the first mask 200 to obtain the reconstructed second damaged turbulent flow field.

In this embodiment, the downsampling module 402 reduces the spatial resolution of the input turbulent flow field data and extracts high-level flow field features. The fast Fourier residual module improves the reconstruction accuracy of high wavenumber information in the turbulent flow field. By performing a deconvolution operation, the upsampling module 404 can gradually increase the size of the turbulent flow field data and reduce a number of channels, thereby gradually restoring the details and structure of the turbulent flow field, and thus more accurately restoring the structure of the damaged turbulent flow field.

In some embodiments, the downsampling module 402 includes a series of convolutional and pooling layers which can reduce the spatial resolution of the input turbulent flow field data and extract the high-level flow field features. By performing multiple convolution and pooling operations, the downsampling module 402 can gradually reduce the size of the turbulent flow field data and increase the number of channels to obtain higher-level feature representations.

In some embodiments, the fast Fourier residual module 403 may include multiple feedforward network units similar to ResNet and two fast Fourier convolutions (FFCs). The fast Fourier residual module 403 is configured to extract the turbulent flow field information in the wavenumber space, which improves the reconstruction accuracy in high wavenumber information of the turbulent flow fields.

In some embodiments, the upsampling module 404 includes a series of deconvolution and convolutional layers. The upsampling module 404 is configured to remap the high-level features extracted by the fast Fourier residual module 403 back to the spatial dimension of the original turbulent flow field and restore detailed information. By performing a deconvolution operation, the upsampling module 404 can gradually increase the size of the turbulent flow field data and reduce the number of channels, thereby gradually restoring the details and structure of the turbulent flow field.

In some embodiments, the discriminator network module configures the discriminator network. The discriminator network receives the second and the first damaged turbulent flow fields, and divides the second and the first damaged turbulent flow fields into multiple local flow field regions. The discriminator network module performs feature extraction and representation learning on the local flow field regions, and calculates a local discrimination result for each local flow field region. The discriminator network module summarizes the local discrimination results using an aggregation method and calculating an overall discrimination result, wherein the overall discrimination result is configured to determine an authenticity of the second damaged turbulent flow field and calculate the adversarial loss function L_{adv}. In this embodiment, the discriminator network is configured to evaluate and improve the local details of the reconstructed turbulent flow field (the second damaged turbulent flow field), and is applied to each iteration process to promote the generator network to generate more realistic flow field data.

In some embodiments, as shown in FIG. 5, the turbulent flow field 501 is divided into multiple local flow field regions 5011. The turbulent flow field 501 includes the second and the first damaged turbulent flow fields. In this embodiment, the turbulent flow field 501 is divided into 16 non-overlapping local flow field regions of the same size. In other embodiments, the local flow field regions may overlap with each other, and the size of each local flow field region can be adjusted according to specific applications.

In some embodiments, as shown in FIG. 6, feature extraction and representation learning are performed on each local flow field region 5011 using the discriminator network 500. The discriminator network 500 includes multiple convolutional layers 502. Each convolutional layer 502 employs learnable convolution kernels to extract features of the local flow field region. The discriminator network 500 can further include pooling layers, batch normalization layers, and activation functions (such as LeakyReLU) between the convolutional layers 502, which improves the representational and discriminative abilities of the discriminator network 500. The discriminator network 500 generates a local discrimination result for each local flow field region 5011. The local discrimination result may be a binary classification (true/false) or a probability value, indicating the probability that the local flow field region is a real flow field. In this embodiment, the output of the discriminator network 500 is a two-dimensional array 503 containing binary labels. When all values in the two-dimensional array 503 corresponding to the local flow field regions 5011 are 1, it indicates high authenticity of the reconstructed flow field. Conversely, when all values are 0, it indicates low authenticity of the reconstructed flow field.

In this embodiment, the discriminator network is a PatchGAN discriminator network. Thus, local details and structural information of the turbulent flow field can be captured, enabling the discriminator network to evaluate the authenticity of the reconstructed flow field in more detail. The PatchGAN discriminator network aggregates all local discrimination results using global pooling, fully-connected layers, or other aggregation methods. The final discrimination result represents the authenticity score of the flow field.

These embodiments shall not limit the scope of protection of the technical solution. Any modifications, equivalent substitutions, and improvements made within the spirit and principles of the foregoing embodiments shall be included within the scope of protection of the technical solution.

1. A method for reconstructing missing information in a damaged turbulent flow field, wherein the damaged turbulent flow field comprises multiple damaged regions and multiple intact regions, and the method comprises:
generating a first mask based on the shape and distribution of the damaged regions, wherein the first mask comprises multiple 0-value regions each having a pixel value of 0 and multiple non-zero regions each having a pixel value of 1, and the 0-value regions of the first mask cover all the damaged regions;
randomly generating a second mask according to the first mask, wherein the second mask comprises multiple 0-value regions each having a pixel value of 0 and multiple non-zero regions each having a pixel value of 1, and the 0-value regions of the second mask cover a portion of the intact regions, and the 0-value regions of the first mask and the 0-value regions of the second mask do not overlap with each other;
overlaying the first mask with the damaged turbulent flow field to obtain a preprocessed first damaged turbulent flow field;
inputting the first damaged turbulent flow field and the second mask into a generator network to output a first reconstructed turbulent flow field, and overlaying the first reconstructed turbulent flow field with the first mask to obtain a reconstructed second damaged turbulent flow field;
calculating a loss function of a network framework and adjusting network parameters based on the second and the first damaged turbulent flow fields;
iterating operations from generating the second mask to calculating the loss function and adjusting the network parameters based on the second and the first damaged turbulent flow fields, until a network training converges; and
preprocessing the damaged turbulent flow field and inputting the preprocessed damaged turbulent flow field into the converged generator network to obtain a complete turbulent flow field.

2. The method according to claim 1, wherein the first mask is uniquely determined by the corresponding damaged turbulent flow field, the second mask is randomly generated during the network training process, and a reconstruction accuracy of the complete turbulent flow field is evaluated by comparing the original damaged turbulent flow field with the complete turbulent flow field; and a proportion of the 0-value regions of the second mask is adjusted according to the reconstruction accuracy.

3. The method according to claim 1, wherein the calculating a loss function of a network framework and adjusting network parameters based on the second and the first damaged turbulent flow fields comprises:
comparing the second damaged turbulent flow field with the first damaged turbulent flow field, and calculating a conventional pixel mean square error loss function Lₚᵢₓ;
calculating an adversarial loss function L_{adv} of the network framework;
inputting the second and the first damaged turbulent flow fields into a pretrained network comprising a zero module, a first module, a second module, a third module, a fourth module and a fifth module in sequence; calculating feature mappings of the second and the first damaged turbulent flow fields in the first module, the second module, the third module and the fourth module, calculating mean square errors MSE₁, MSE₂, MSE₃ and MSE₄ respectively corresponding to the feature mappings, and calculating a weighted average value: L_{fm}=α₁MSE₁+α₂MSE₂+α₃MSE₃+α₄MSE₄;
wherein the loss function is a combined loss function: L_{final}=αLₚᵢₓ+βL_{adv}+γL_{fm}, wherein α, β, and γ are weight coefficients.

4. The method according to claim 3, wherein the generator network comprises a downsampling module, a fast Fourier residual module, and an upsampling module; the downsampling module is configured to perform feature extraction and dimensionality reduction on the first damaged turbulent flow field inputted to the generator network, the fast Fourier residual module is configured to extract high-level features of the turbulent flow field in a wavenumber space, and the upsampling module is configured to remap the high-level features back to a spatial dimension of an original turbulent flow field and to restore detailed information;
the inputting the first damaged turbulent flow field and the second mask into a generator network to output a first reconstructed turbulent flow field, and overlaying the first reconstructed turbulent flow field with the first mask to obtain a reconstructed second damaged turbulent flow field comprises:
processing the first damaged turbulent flow field and the second mask sequentially through the downsampling module, the fast Fourier residual module, and the upsampling module to output the first reconstructed turbulent flow field, overlaying the first reconstructed turbulent flow field with the first mask to obtain the reconstructed second damaged turbulent flow field;
comparing the second damaged turbulent flow field with the first damaged turbulent flow field through the generator network, and calculating the conventional pixel mean square error loss function Lₚᵢₓ.

5. The method according to claim 3, wherein, before the calculating a loss function of a network framework and adjusting network parameters based on the second and the first damaged turbulent flow fields, the method further comprises:
inputting the second and the first damaged turbulent flow fields into a discriminator network;
dividing the second and the first damaged turbulent flow fields into several local flow field regions using the discriminator network;
performing feature extraction and representation learning on the local flow field regions using the discriminator network;
calculating a local discrimination result for each local flow field region using the discriminator network;
summarizing the local discrimination results using an aggregation method and calculating an overall discrimination result, wherein the overall discrimination result is configured to determine an authenticity of the second damaged turbulent flow field and calculate the adversarial loss function L_{adv}.

6. A system for reconstructing missing information in a damaged turbulent flow field, wherein the damaged turbulent flow field comprises multiple damaged regions and multiple intact regions, and the system comprises:
a data preprocessing module, configured to generate a first mask based on the shape and distribution of the damaged regions and randomly generate a second mask based on the first mask; wherein the first mask comprises multiple 0-value regions each having a pixel value of 0 and multiple non-zero regions each having a pixel value of 1, and the 0-value regions of the first mask cover all of the damaged regions, the second mask comprises multiple 0-value regions each having a pixel value of 0 and multiple non-zero regions each having a pixel value of 1, and the 0-value regions of the second mask cover a portion of the intact regions; the 0-value regions of the first mask and the 0-value regions of the second mask do not overlap with each other; the first mask is overlaid on the damaged turbulent flow field to obtain a preprocessed first damaged turbulent flow field;
a generator network module, configured to receive the first damaged turbulent flow field and the second mask, output a complete first reconstructed turbulent flow field, and overlay the first reconstructed turbulent flow field with the first mask to obtain a reconstructed second damaged turbulent flow field;
a training module, configured to calculate a loss function of a network framework based on the second and the first damaged turbulent flow fields, adjust network parameters, and iterate operations from generating the second mask to calculating the loss function based on the second and the first damaged turbulent flow fields, until a network training converges; and
a reconstruction module, configured to, after the network training converges, preprocess the damaged turbulent flow field and input the preprocessed damaged turbulent flow field into the converged generator network module to obtain a complete turbulent flow field.

7. The system according to claim 6, wherein when a pixel mean square error or a network-level feature mapping mean square error between the second and the first damaged turbulent flow fields is less than a threshold, the network training is deemed converged.

8. The system according to claim 6, further comprising a discriminator module configured to calculate an adversarial loss function L_{adv} of the network framework;
wherein the generator network module is further configured to compare the second damaged turbulent flow field with the first damaged turbulent flow field, and calculate a conventional pixel mean square error loss function Lₚᵢₓ;
and a pretrained network configured by the training module comprises a zero module, a first module, a second module, a third module, a fourth module and a fifth module in sequence, which calculates feature mappings of the second and the first damaged turbulent flow fields in the first module, the second module, the third module and the fourth module; wherein mean square errors MSE₁, MSE₂, MSE₃, MSE₄ respectively corresponding to the feature mappings are calculated, and a weighted average value is given as L_{fm}=α₁MSE₁+α₂MSE₂+α₃MSE₃+α₄MSE₄, wherein α₁, α₂, α₃ and α₄ are weight coefficients;
wherein the loss function is a combined loss function: L_{final}=αLₚᵢₓ+βL_{adv}+γL_{fm}, wherein α, β, and γ are weight coefficients.

9. The system according to claim 8, wherein the generator network module comprises a downsampling module, a fast Fourier residual module, and an upsampling module; the downsampling module is configured to perform feature extraction and dimensionality reduction on the first damaged turbulent flow field inputted to the generator network, the fast Fourier residual module is configured to extract high-level features of the turbulent flow field in a wavenumber space, and the upsampling module is configured to remap the high-level features back to a spatial dimension of an original turbulent flow field and restore detailed information;
the first damaged turbulent flow field and the second mask are sequentially processed through the downsampling module, the fast Fourier residual module, and the upsampling module to output the first reconstructed turbulent flow field.

10. The system according to claim 8, wherein the discriminator module is configured to receive the second and the first damaged turbulent flow fields, divide the second and the first damaged turbulent flow fields into several local flow field regions, perform feature extraction and representation learning on the local flow field regions, calculate a local discrimination result for each local flow field region, and aggregate the local discrimination results using an aggregation method to calculate an overall discrimination result; the overall discrimination result is configured to judge an authenticity of the second damaged turbulent flow field and calculate the adversarial loss function L_{adv}.

11. An electronic apparatus having a memory, a processor, and a computer program stored in the memory and capable of running in the processor, wherein, when being executed by the processor, the computer program implements the steps in the method for reconstructing missing information in a damaged turbulent flow field of claim 1.

12. An electronic apparatus having a memory, a processor, and a computer program stored in the memory and capable of running in the processor, wherein, when being executed by the processor, the computer program implements the steps in the method for reconstructing missing information in a damaged turbulent flow field of claim 2.

13. An electronic apparatus having a memory, a processor, and a computer program stored in the memory and capable of running in the processor, wherein, when being executed by the processor, the computer program implements the steps in the method for reconstructing missing information in a damaged turbulent flow field of claim 3.

14. An electronic apparatus having a memory, a processor, and a computer program stored in the memory and capable of running in the processor, wherein, when being executed by the processor, the computer program implements the steps in the method for reconstructing missing information in a damaged turbulent flow field of claim 4.

15. An electronic apparatus having a memory, a processor, and a computer program stored in the memory and capable of running in the processor, wherein, when being executed by the processor, the computer program implements the method for reconstructing missing information in a damaged turbulent flow field of claim 5 16. A computer-readable storage medium with a computer program stored thereon, wherein, when being executed by the processor, the computer program implements the steps in the method for reconstructing missing information in a damaged turbulent flow field of claim 1.

17. A computer-readable storage medium with a computer program stored thereon, wherein, when being executed by the processor, the computer program implements the steps in the method for reconstructing missing information in a damaged turbulent flow field of claim 2.

18. A computer-readable storage medium with a computer program stored thereon, wherein, when being executed by the processor, the computer program implements the steps in the method for reconstructing missing information in a damaged turbulent flow field of claim 3.

19. A computer-readable storage medium with a computer program stored thereon, wherein, when being executed by the processor, the computer program implements the steps in the method for reconstructing missing information in a damaged turbulent flow field of claim 4.

20. A computer-readable storage medium with a computer program stored thereon, wherein, when being executed by the processor, the computer program implements the steps in the method for reconstructing missing information in a damaged turbulent flow field of claim 5.
